(19) United States
(12) Patent Application Publication
(10) Pub. No.: US 2013/0024402 A1
(43) Pub. Date: Jan. 24, 2013

(54) APPARATUS AND METHOD OF SECURING ARTICLES AND ACCESSORIES IN VEHICLES PASSING THROUGH AUCTION

(71) Applicant: Nick Cundiff, Fort Lauderdale, FL (US)

(72) Inventor: Nick Cundiff, Fort Lauderdale, FL (US)

(21) Appl. No.: 13/355,791

(22) Filed: Jan. 23, 2012

Related U.S. Application Data
(60) Provisional application No. 61/434,878, filed on Jan. 21, 2011.

(51) Int. Cl. G06Q 90/00

(52) U.S. Cl. 705/500

(57) ABSTRACT

An apparatus and method for maximizing the auction value of vehicles by confirming and inventorying the vehicle contents, namely, accessories and components, and securing said contents within the vehicle in a locked and secured tamper-resistant bag as the vehicle passes through auction. A lockable, cut and tear resistant bag is adapted for secured attachment inside a vehicle. A certified inventory checklist is further provided to allow security personnel to inventory vehicle accessories and components placed into the locking bag. The bag is locked in the vehicle, such as to the door handle, under the seat, to the seat belt harness, or other vehicle structure using a locking cable. When the vehicle exits the auction, security personnel unlock the bag thereby allowing the bag and accessories and components contained therein to leave with the vehicle.

### CROSS REFERENCE TO RELATED APPLICATIONS

This application claims the benefit of provisional U.S. Patent Application Ser. No. 61/434,878, filed on Jan. 21, 2011.

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all rights whatsoever.

### BACKGROUND OF THE INVENTION

1. Field of the Invention

The present invention generally relates to vehicles passing through vehicle auction, and more particularly to apparatus and methods for securing vehicle-related documents, accessories and inventory by secure in-vehicle storage while the vehicles pass through auction.

2. Description of Related Art

Automobile auctions provide means for selling vehicles via an auction format, and play a major role as a wholesale market for used vehicles. Automobile auctions further provide a primary outlet for finance companies to dispose of their large volume of off-lease returns, for rental and other companies to sell off aging fleets, and for car dealerships to dispose trade-ins and other unwanted inventory. Some auctions are used by banks, the IRS, and other governmental agencies to sell vehicles that have been repossessed for failure to make monthly payments or failure to pay taxes, or for vehicles that were seized by the FBI, DEA, or local police.

A dealer auction is a specialized form of “closed auction” meaning that only automobile dealers, and not the public, are allowed to participate. Millions of vehicles are sold at dealer auctions every year as dealers attempt to minimize the costs of maintaining aging inventory. Most vehicles sold at dealer auctions are off-lease returns, replaced rental fleets, company cars, repossessed vehicles, and trade-ins.

The overall condition of vehicles sold at auction is an important factor considered by dealers participating at dealer auctions. As with any used vehicle, overall vehicle condition varies greatly. Vehicle condition and appearance may suffer from stained upholstery, scratched bumpers, body dings, chips, and dents, and missing accessories. While upholstery stains, and minor body defects can be remedied inexpensively by conventional repair methods known in the art, missing and lost vehicle accessories remain a significant problem in the art of vehicle auctions. More particularly, vehicles that go to auction often have a number of components and accessories, the presence or absence of which can significantly affect the value of the vehicle. Among the components and accessories, are navigation system discs, shift knobs, headphones, spare keys, owner's manuals, etc. It is not uncommon for the accessories to be scattered throughout the vehicle, such as in the trunk, glove box, storage locations, under the seats, or in, other accessible storage locations. A significant problem associated with vehicles passing through auction is that the accessories are often stolen or misplaced while the vehicles are processed and passed through auction. A number of the accessories, such as shift knobs, are can comprise valuable highly sought vehicle accessories. Since replacement of such components and accessories can be expensive and time consuming, missing items can result in a vehicle selling for a lesser amount.

As a result of the economic impact of lost or stolen vehicle components and accessories in the field of vehicle auctions, there exists a need for apparatus and methods for accessory inventory control and secure in-vehicle storage of vehicle-related accessories. There particularly exists a need for such apparatus and methods for use with vehicles passing through auction. The background art has not adequately addressed this need. For example, U.S. Pat. No. 338,846, issued to Kimber, discloses a means for securing satchels and bags to car seats. Kimber discloses providing a chain, flexible wire or cord having loops or rings at the ends to allow a lockable bag to be secured to a post or rail of the seat. Kimber's teaching is very rudimentary, uses bulky satchels, and fails to address the inventory of accessories and components. U.S. Pat. No. 5,542,590, issued to Pfitzenmaier, discloses theft resistant articles storage pouch adapted to attach to an automobiles existing safety belt hardware. Published U.S. Patent Application 2004/0040351, to Alcott, discloses an article of manufacture for securing vehicle keys and other valuables for attachment to a trailer hitch using a locking pin and padlock.

While the devices of the background art are generally suitable for the limited applications for which they were intended, there remains a need in the art for apparatus and methods for providing vehicle accessory inventory control and secured in-vehicle storage of vehicle accessories, components, and documents for vehicles passing through auction.

### BRIEF SUMMARY OF THE INVENTION

The present invention overcomes the limitations and disadvantages present in the art by providing a lockable, cut and tear resistant transparent bag or pouch adapted to receive vehicle contents, including vehicle components and accessories, for secured attachment inside a vehicle. A certified inventory checklist is provided to allow security personnel to inventory vehicle accessories and components gathered and placed into the locking pouch. The pouch is locked in the vehicle, such as to the door handle, under the seat, to the seat belt harness, or other vehicle structure using a locking cable. When the vehicle exits the auction, security personnel unlock the pouch thereby allowing the pouch containing vehicle accessories and components to leave with the vehicle and pass to the new owner.

Accordingly, it is an object of the present invention to provide an apparatus and method specifically designed for use in inventory and secured storage of vehicle accessories and components for vehicles passing through auction.

Another object of the present invention is to provide a transparent, tamper-proof pouch and inventory checklist to allow security personnel to quickly inventory vehicle accessories and secure the accessories directly within the vehicle as it passes through auction.

These and other objects are met by the present invention which will become more apparent from the accompanying drawing and the following detailed description of the drawings and preferred embodiments.

### BRIEF DESCRIPTION OF THE SEVERAL VIEWS OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a checklist in accordance with the present invention;

FIG. 2 depicts a tamper resistant bag in accordance with the present invention;

FIG. 3 depicts a cable lock for use in locking a tamper resistant bag in accordance with the present invention;

FIG. 4 depicts a tamper-resistant bag containing vehicle accessories and inventory checklist in accordance with the present invention;

FIG. 5 illustrates a tamper resistant bag in accordance with the present invention secured to a vehicle hand grip;

FIG. 6 illustrates a tamper resistant bag in accordance with the present invention secured to a vehicle door handle; and

FIG. 7 illustrates a tamper resistant bag in accordance with the present invention secured to a vehicle seat bar.

### DETAILED DESCRIPTION OF THE INVENTION

With reference now to the drawings, there is depicted a lockable, tamper-resistant pouch and inventory checklist adapted for locked attachment within a vehicle to secure vehicle accessories and components in accordance with the present invention.

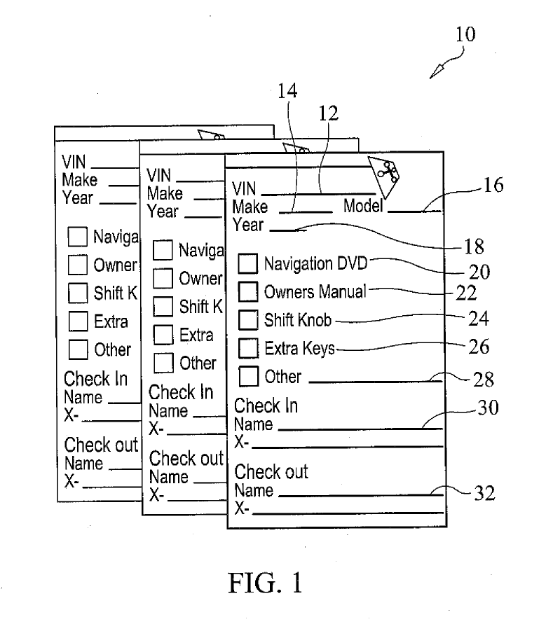

FIG. 1 depicts a vehicle inventory checklist 10 which allows security personnel to certify the inventory of vehicle accessories and components which have been located in the vehicle for placement into the locking pouch 40 as more fully disclosed below. Checklist 10 includes alpha-numeric indicia that allow for the identification of basic vehicle information including the vehicle identification number (“VIN”) 12, make 14, model 16, and year 18 of the vehicle. In addition, simple “check” boxes are provided to allow for an inventory of various common vehicle accessories and components including the navigation DVD 20, owner's manual 22, shift knob 24, extra keys 26, and other (i.e. misc. accessories) 28. Finally, checklist 10 includes indicia to confirm the identity of the auction's check-in person 30, and check-out person 32. As used herein the term “indicia” shall broadly be construed to mean written words, or check boxes, or lines and/or underlines for receiving written information. As should be apparent, checklist 10 is intended to be filled out by auction house personnel immediately upon receipt of the vehicle (i.e. prior to auction) to provided documented inventory confirmation of the vehicle contents.

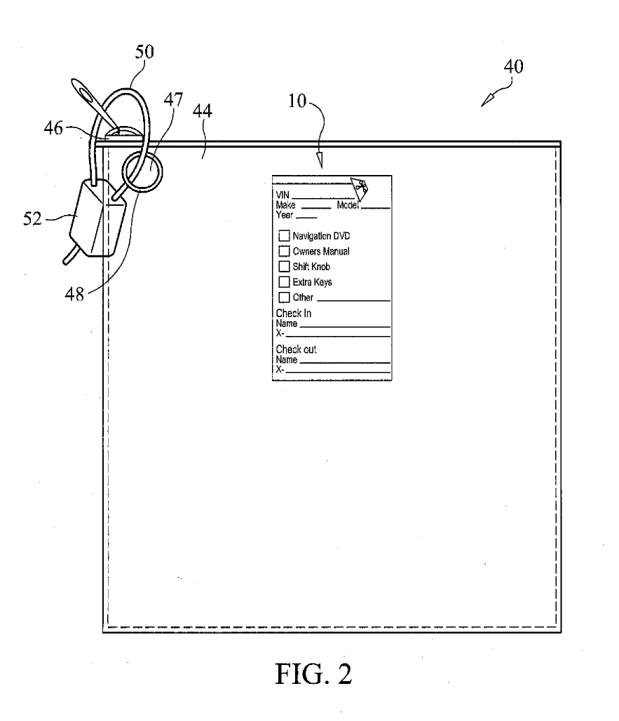

FIG. 2 depicts a transparent, tamper-resistant bag or pouch, generally referenced as 40, for use in containing vehicle accessories and components. Pouch 40 is preferably fabricated from transparent or translucent material 42 characterized as being cut and tear resistant. Pouch 40 may be uniformly formed of such material or may have a transparent portion that allows for visual inspection of the pouch contents. It is important that both sides of the pouch have at least a portion thereof formed to be transparent to ensure that the checklist may be viewed regardless of how it is inserted into the pouch. In a preferred embodiment, pouch 40 has first and second opposing sides, and is sized to be approximately 10.0 inches wide and 11.0 inches long, however, any suitable dimensions are considered within the scope of the present invention. Furthermore, pouch 40 may be formed of a single piece of material such that the first and second sides correspond to spatial references as opposed to individual attached pieces. Pouch 40 preferably includes on openable top portion 44 having a slidable closure 46, such as a zipper or zip-lock closure, to allow for rapid opening and closing thereof. It is important that slidable closure 46 define a through-bore, aperture, or loop through which a cable may be inserted as more fully discussed below. As should be apparent closure 46 is configurable between an open configuration wherein articles may be inserted and/or removed from bag 40, and a closed configuration wherein articles are secured within pouch 40. Top potion 44 further preferably includes aligned apertures 47 (i.e. first/front and second/rear sides), each of which is reinforced by a grommet 48 to allow for threaded insertion of a cable 50 therethrough. FIG. 4 depicts a tamper-resistant bag 40 containing vehicle accessories and an inventory checklist 10 with the slidable closure 46 disposed in the closed configuration. It is important for aligned apertures 47 to be positioned near a side edge of the pouch corresponding to the position of slidable closure 46 when in the closed configuration.

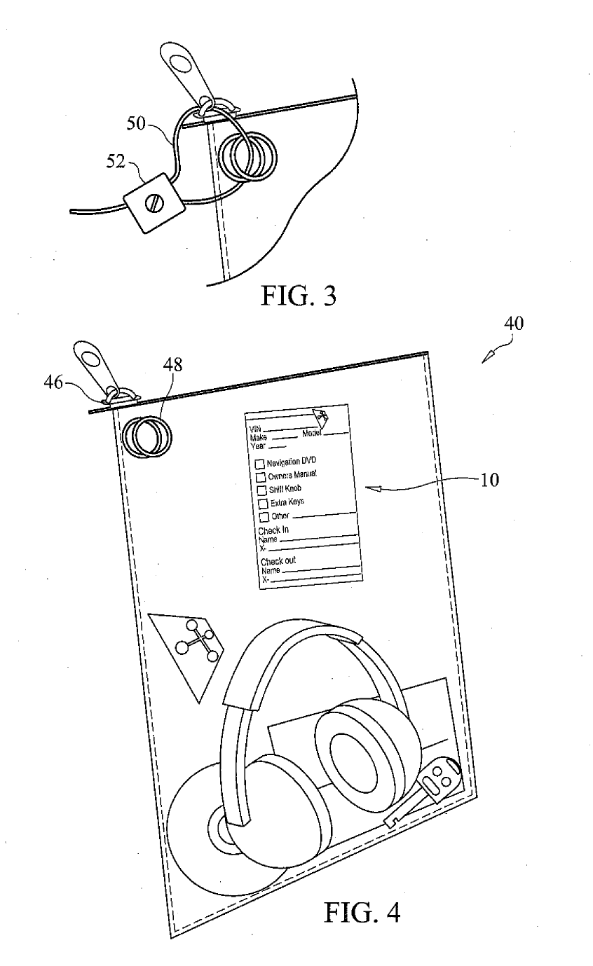

Cable 50 is characterized as comprising a flexible member having high tensile strength, such as a braided wire strand cable, or any other suitable cord, chain, or cable. Cable 50 further includes a locking member 52, that functions to secure the cable to form a loop thereby enabling the cable to be inserted through aperture 47, a loop or aperture associated with slidable closure 46, as well as a vehicle structural member (such as a door handle), whereby bag 40 is secured to the vehicle with the secure closure 46 in the closed configuration thereby preventing access to the articles contained within bag 40. It is important for cable 50 to be drawn fully when secured such that slidable closure 46 cannot be opened. FIG. 3 depicts a cable lock 52 for use in locking a tamper resistant pouch in accordance with the present invention.

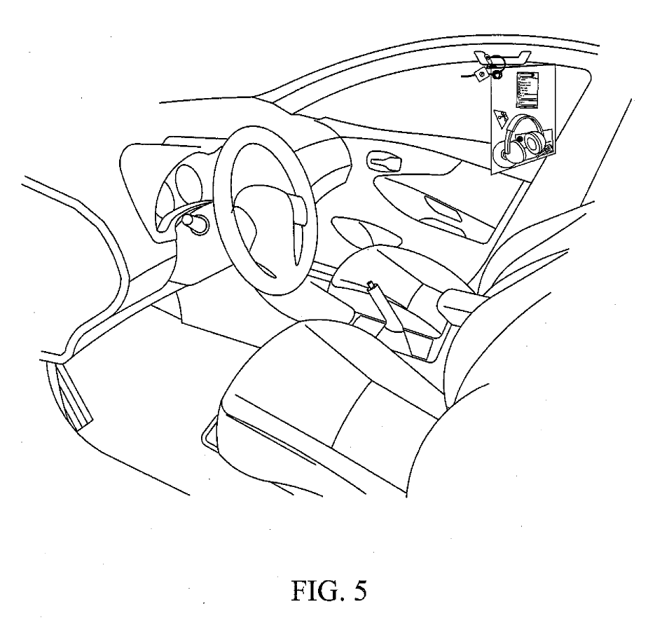

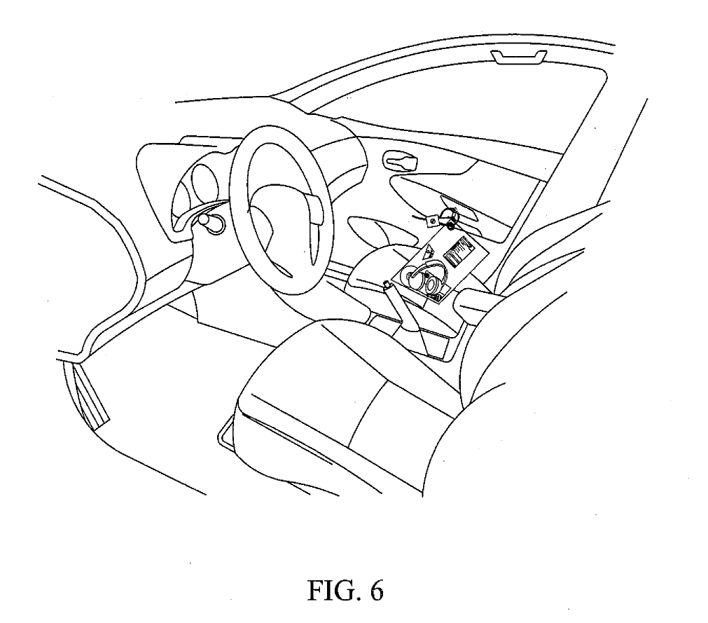

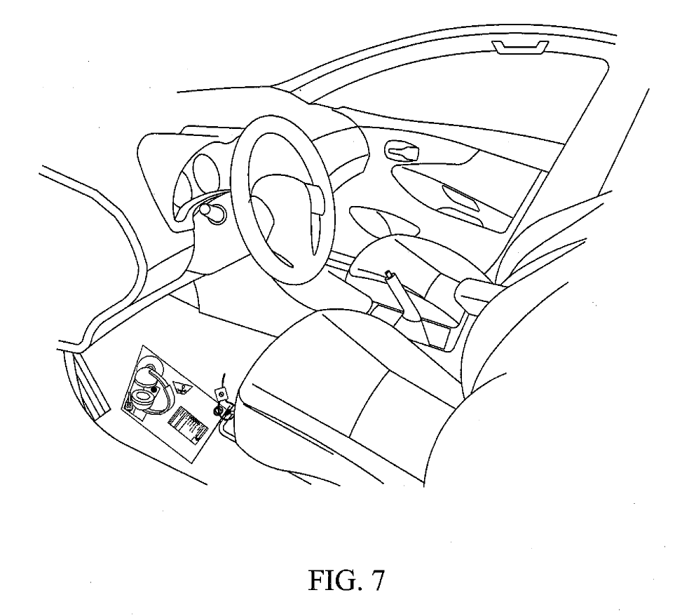

As should be apparent, bag 40 may be secured to any suitable structural vehicle member, such as the steering column, seat structure, door handle, grab handle, etc. FIG. 5 illustrates a tamper resistant bag in accordance with the present invention secured to a vehicle hand grip. FIG. 6 illustrates a tamper resistant bag in accordance with the present invention secured to a vehicle door handle. FIG. 7 illustrates a tamper resistant bag in accordance with the present invention secured to a vehicle seat bar.

In accordance with the method of the present articles are inventoried and secured in accordance with the following steps: (1) gather all vehicle accessories and components from throughout the vehicle; (2) open pouch 40 by sliding closure 46 to the open configuration, and place the accessories and components into the pouch; (3) fill out checklist 10 by filling in the vehicle information and confirming the contents of the pouch; (4) have the auction attendant sign the checklist and place the checklist in the bag; (5) close the bag by sliding closure 46 to the closed configuration; (6) running cable 50 through apertures 47, a portion of closure member 46, and a structural vehicle component; (7) pulling the cable tight and securing the cable with a locking member; (8) passing the vehicle through auction; (9) as the vehicle exists the auction, unlocking the locking member and cable and having an auction attendant sign checklist 10 certifying the contents of bag 40.

The present inventing thus maximizes the auction value of vehicles by providing a system and method for confirming and inventorying important and/or valuable vehicle contents, namely, accessories and components, and securing said contents within the vehicle in a locked and secured tamper-resistant bag as the vehicle passes through auction.

The instant invention has been shown and described herein in what is considered to be the most practical and preferred embodiment. It is recognized, however, that departures may be made therefrom within the scope of the invention and that obvious modifications will occur to a person skilled in the art.

What I claim is:

1. A system for taking inventory of, and securing, motor vehicle contents to maximize the value of a vehicle passing through auction, said system comprising:
a checklist having indicia thereon to allow auction personnel to populate the checklist with written information regarding vehicle identification and the presence of common vehicle contents to allow a user to develop a written record confirming the presence of said components;
a pouch having opposing first and second sides fabricated from tear-resistant material, each of said sides having at least a portion thereof formed of transparent material;
said pouch having an top portion having a slidable closure configurable between an open configuration and a closed configuration, said closure having a portion thereof defining a through-bore;
each of said first and second sides including aligned reinforced apertures disposed in proximity to the slidable closure when disposed in said closed configuration;
a flexible, high tensile strength cable sized for insertion through said pouch reinforced apertures and said slidable closure through-bore; and
a locking member adapted to secure said cable to form a loop of user selected size;
whereby said checklist allows for the creation of a written record of vehicle information, and inventory of vehicle contents, said checklist and vehicle contents being inserted in said pouch, and said pouch being secured in said closed configuration, and said pouch being secured to the vehicle in said closed configuration by said cable and said locking member.

2. A system for taking inventory of, and securing, motor vehicle contents according to claim 1, wherein said checklist indicia includes indicia relating to the vehicle identification number, vehicle make, model, and year.

3. A system for taking inventory of, and securing, motor vehicle contents according to claim 1, wherein said checklist indicia includes indicia relating to vehicle components and accessories including navigation DVD, owner's manual, shift knob, and keys.

4. A system for taking inventory of, and securing, motor vehicle contents according to claim 1, wherein said checklist indicia includes indicia relating to the identity the vehicle check-in person and check-out person.

5. A system for taking inventory of, and securing, motor vehicle contents for a vehicle passing through auction, said system comprising:
a checklist having indicia thereon to allow a user to populate the checklist with written information including the vehicle identification number, vehicle make, model, and year, said checklist further having indicia relating to common vehicle contents including, navigation DVD, owner's manual, shift knob, and keys to allow a user to develop a written record confirming the absence and/or presence of said components;
a pouch having opposing first and second sides fabricated from tear-resistant material, each of said sides having at least a portion thereof formed of transparent material;
said pouch having an top portion having a slidable closure configurable between an open configuration and a closed configuration, said closure having a portion thereof defining a through-bore;
each of said first and second sides including aligned reinforced apertures disposed in proximity to the slidable closure when disposed in said closed configuration;
a flexible, high tensile strength cable sized for insertion through said pouch reinforced apertures and said slidable closure through-bore; and
a locking member adapted to secure said cable to form a loop of user selected size;
whereby said checklist allows for the creation of a written record of vehicle information, and inventory of vehicle contents, said checklist and vehicle contents being inserted in said pouch, and said pouch being secured in said closed configuration, and said pouch being secured to the vehicle in said closed configuration by said cable and said locking member.

6. A system for taking inventory of, and securing, motor vehicle components and accessories according to claim 5, wherein said checklist indicia includes indicia relating to the identity the vehicle check-in person and check-out person.

7. A method for taking inventory of, and securing, motor vehicle contents to maximize the value of vehicles passing through auction, said method including the steps of:
(a) providing a checklist having indicia thereon to allow auction personnel to populate the checklist with written information regarding vehicle identification and common vehicle contents to allow a user to develop a written record confirming the presence of said components;
(b) providing a pouch having opposing first and second sides fabricated from tear-resistant material, each of said sides having at least a portion thereof formed of transparent material, said pouch having an top portion having a slidable closure configurable between an open configuration and a closed configuration, said closure having a portion thereof defining a through-bore, each of said first and second sides including aligned reinforced apertures disposed in proximity to the slidable closure when disposed in said closed configuration;
(c) providing a flexible, high tensile strength cable sized for insertion through said pouch reinforced apertures and said slidable closure through-bore;
(d) providing a locking member adapted to secure said cable to form a loop of user selected size;
(e) gathering vehicle contents selected from the group including: navigation DVD, owner's manual, shift knob, and keys;
(f) placing said vehicle contents in said pouch;
(g) filling out said checklist to include vehicle information and confirmation of the contents placed in said pouch;
(h) having the auction attendant sign the checklist and place the checklist in the pouch;
(i) closing the pouch by sliding said closure to the closed configuration; and
(j) securing said pouch to the vehicle in a closed configuration.

8. A method for taking inventory of, and securing, motor vehicle contents according to claim 7, wherein said checklist indicia includes indicia relating to the vehicle identification number, vehicle make, model, and year.

9. A method for taking inventory of, and securing, motor vehicle contents according to claim 7, wherein said checklist indicia includes indicia relating to vehicle components and accessories including navigation DVD, owner's manual, shift knob, and keys.

10. A method for taking inventory of, and securing, motor vehicle contents according to claim 7, wherein said checklist indicia includes indicia relating to the identity the vehicle check-in person and check-out person.
